(19) United States
(12) Patent Application Publication
(10) Pub. No.: US 2013/0135455 A1
(43) Pub. Date: May 30, 2013

(54) Face-Directional Recognition Driven Display Control

(71) Applicants: Johan Hjelm, Tokyo (JP); Shingo Murakami, Kanagawa (JP); Toshikane Oda, Tokyo (JP)

(72) Inventors: Johan Hjelm, Tokyo (JP); Shingo Murakami, Kanagawa (JP); Toshikane Oda, Tokyo (JP)

(73) Assignee: Telefonaktiebolaget L M Ericsson (publ), stockholm (SE)

(21) Appl. No.: 13/814,816

(22) PCT Filed: Aug. 11, 2010
(86) PCT No.: PCT/JP2010/063893

§ 371 Date: Feb. 7, 2013

(51) Int. Cl. G06Q 30/02

(52) U.S. Cl. CPC G06Q 30/0261
USPC 348/77

(57) ABSTRACT

To present a more attractive image showing a product before a customer for advertisement, a display control system is provided. This system is supposed to be deployed in different sites of a store, shop or shopping mall. The system includes: a server for storing image data representing a plurality of images corresponding to advertisement contents; a controller connected to the server; and a plurality of displays and cameras arranged near an exhibited product for advertisement. When a person is near the exhibited product, a plurality of cameras capture the person from different angles, captured image data is sent to the controller and processed and analyzed by the controller. Then, the controller infers the person's interest, selects a more suitable image to the person based on the person's interest, and transmits image data to any of the displays so as to change a displayed image according to the person's interest.

### TECHNICAL FIELD

This invention relates to a display control method, and particularly to a method of controlling what to display in display screens according to a person's face movement.

### BACKGROUND

Today, there are many advertising approaches to attract people to purchase products, goods, foods, etc. For example, when people are enjoying window-shopping at the shopping mall, their eyed keep moving here and there, and they usually take a glance at a particular product. The period of their glance may be just one second or less. In view of advertisement, it is vital to get their attention within a second by showing any intended product someway.

Moreover, people's interests and concerns are different, depending on season, time, sex, age, job, etc. Taking these factors into consideration, to timely provide an attractive advertisement with people is a very challenging task. It has been considered as one of the most effective ways that a display screen is adaptively controlled.

For example, “Person Aware Advertising Displays: Emotional, Cognitive, Physical Adaptation Capabilities for Contract Exploitation”, Gilbert Beyer et al., Pervasive Advertising Proceedings from the 1st Workshop @ Pervasive 2009, page 13-17 (which is available by accessing to http://www.pervasiveadvertising.org/index.php) proposed that advertising display may react in an adaptive way to psycho-physiological states. According to this article, advertising display control employs two adaptations: (1) adaptation to the active environment; and (2) adaptation to the individual user. More specifically, depending on how many passersby are in front of the display, the contents of the display change. Depending on the user's awareness of the contents and the user's facial expression, the contents of the display change.

In this way, when a user looks in certain ways at the display, the contents of the display change as a result.

Currently, the conventional system as discussed above only works for controlling individual displays. Further, the system simply works as control mechanisms, i.e. the user has to explicitly interact with the display to achieve an action.

However, in the ordinary advertising environment, users typically do not look long enough at a display as mentioned above.

It is reported by “Overcoming Assumptions and Uncovering Practices: When does the Public Really Look at Public Displays?”, Elaine M. Huang et al., the Proceedings of the 6^{th} International Conference (2008) on Pervasive Computing Sydney, Australia (which is available by accessing to “http://www.elainehuang.com/huang-koster-borchers-perv2008.pdf”) that:

(1) When people turned their heads to glance at the display, they usually only looked in the direction of the display for one or two seconds. Beyond that, there were extremely few incidents of people slowing down as they passed the displays, and only a few extremely rare occurrences of people actually stopping or changing their walking path to look at the display content. On very rare occasions people would stop to look for as long as 7 or 8 seconds;

(2) Displays that show video contents tended to capture the eye somewhat longer; although passersby did not frequently stop to watch the video, many did continue to look at the display for a few more seconds as they walked past. Previous laboratory studies suggest that glances of more than 800 ms suggest that the glances are intentional on the part of the passersby;

(3) Many of the displays show a few sentences of text at a time in the form of product description, a fun fact, a description of a service and a corresponding URL, or a description of an upcoming event. It is unlikely that passersby are actually reading the content in its entirety. It seems that upon looking a display, people make extremely rapid decisions about the value and relevance of large display content, and that content that requires more than a few seconds to absorb is likely to be dismissed or ignored by passersby;

(4) Such displays in themselves are not attracting the gaze of the viewer; it is something else that attracts the view and then it is captured by the display. For example, a bookstore window display contained a large display with advertisements, some soccer merchandise, and a poster with some photographs of soccer players on it. Nearly all of approximately 80 passersby who glanced at the display came from the same direction; they started by looking at the items while walking by and then glanced at the display at the end. This indicates that large displays may not be as eye-catching as they are often assumed to be, and play a secondary role in attracting attention when in the vicinity of other objects. For example, in a department store, a set of mannequins were placed such that the clothing being sold was at about eye-height, but displays placed directly over them showing fashion videos and advertising services and specials at the store were not viewed by the people who looked at the clothing; and

(5) In one department store, some displays at ends of escalators did receive occasional lingering glances. These were small black and white displays that showed the content of the security video; i.e., real-time video of that particular escalator. This suggests that small displays may encourage or invite prolonged viewing in public spaces to a greater extent than large displays, possibly because people are more used to or more comfortable with looking at small screens for an extended period of time. The use of a smaller display may also create a more private or intimate setting within the greater public setting that leads a viewer to feel less exposed and therefore encourages a longer interaction and greater comfort with displays within a public space.

However, gaze tracking equipment is expensive and hard to control. On the other hand, solutions exist for face identification using mobile phone cameras (see e.g. https://labs.ericsson.com/apis/face-detector), which are cheap and can achieve the same effect, if no desire to actively control the device is intended.

As summarized, the problems to be solved by the present invention are the following;

(1) Detecting which of several screens holds the gaze of the viewer for more than 800 ms, and using this to build an interest profile in an economical way than eye tracking, without requiring specialized devices:

(2) Controlling several displays, in particular small displays, in a group, so that they are coordinated towards the interest profile which is being built up for the particular group of displays; and

(3) Receiving information from external sources, e.g. mobile phones, and correlating this to the displays and the interest profile built from the profile.

### SUMMARY

Accordingly, the present invention is conceived as a response to the above-described disadvantages of the conventional art.

This invention enables the optimization of displays in a store, shopping mall, or market to attract a customer to a particular section of the store shopping mall, or market by combining the monitoring of the customer's facial direction, statistics derived from her/his mobile phone, and campaign directions set from the store control. In addition, the use of face recognition and camera analysis facilitates that when customer watch a display on a particular screen, what the customer watches, and how long the customer watches the screen, can be captured and used for content selection.

More specifically, to solve the above-mentioned problems, according to one aspect of the present invention, there is provided an advertisement system including: a local server; a controller connected to the local server; and a plurality of displays and cameras connected to and controlled by the controller, wherein the plurality of displays and cameras are arranged near an exhibited product for advertisement.

More specifically, the local server comprises a main content storage configured to store image data representing a plurality of images corresponding to advertisement contents. The controller comprises: a receiver unit configured to receive image signals captured by the plurality of cameras; a processing unit configured to process the image signals received by the receiver unit to determine whether or not a person is in an image represented by the image signals, identify where and how long the person is looking at if the person is in the image, and analyze the person's interest based on the identified information; a local content storage configured to store image data which is part of the image data stored in the main content storage of the local server and is delivered from the main content storage of the local server; a display output manager unit configured to select image data suitable for display from the local content storage or the main content storage, based on a result of analysis obtained from the processing unit; and a display driver unit configured to transmit the image data selected by the display output manager unit to any of the plurality of displays where the person is nearby so as to dynamically change any of displayed images according to the person's interest.

According to another aspect of the present invention, there is provided a method of controlling display of image in an advertisement system including: a local server; a controller connected to the local server; and a plurality of displays and cameras connected to and controlled by the controller, wherein the plurality of displays and cameras are arranged near an exhibited product for advertisement.

More specifically, the method comprises the steps of: storing, in a main content image database provided in the local server, image data representing a plurality of images corresponding to advertisement contents; storing, in a local content storage provided in the controller image data which is part of the image data stored in the main content storage and is delivered from the main content storage; receiving, at a receiver unit provided in the controller, image signals captured by the plurality of cameras; processing, at a processing unit provided in the controller, the received image signals to determine whether or not a person is in an image represented by the image signals, identify where and how long the person is looking at if the person is in the image, and analyze the person's interest based on the identified information; selecting, at a display output manager unit provided in the controller, image data suitable for display from the local content storage or the main content storage, based on a result of analysis obtained from the processing unit; and transmitting, by a display driver unit provided in the controller, the selected image data to any of the plurality of displays where the person is nearby so as to dynamically change any of displayed images according to the person's interest.

According to still another aspect of the present invention, there is provided a controller for controlling display of image to be displayed in a display in an advertisement system including: a server connected to the controller for storing image data representing a plurality of images corresponding to advertisement contents; and a plurality of displays and cameras connected to and controlled by the controller, wherein the plurality of displays and cameras are arranged near an exhibited product for advertisement.

More specifically, the controller comprises: a receiver unit configured to receive image signals captured by the plurality of cameras; a processing unit configured to process the image signals received by the receiver unit to determine whether or not a person is in an image represented by the image signals, identify where and how long the person is looking at if the person is in the image, and analyze the person's interest based on the identified information; a content storage configured to store image data which is part of the image data stored in the server and is delivered from the server; a display output manager unit configured to select image data suitable for display from the content storage or the server, based on a result of analysis obtained from the processing unit; and a display driver unit configured to transmit the image data selected by the display output manager unit to any of the plurality of displays where the person is nearby so as to dynamically change any of displayed images according to the person's interest.

According to still another aspect of the present invention, there is provided a server in an advertisement system including: a controller connected to the local server; and a plurality of displays and cameras connected to and controlled by the controller, wherein the plurality of displays and cameras are arranged near an exhibited product for advertisement.

More specifically, the server comprises: a content storage configured to store image data representing a plurality of images corresponding to advertisement contents, wherein the image data is delivered to the controller; a profile aggregation unit configured to aggregate interest profile of individual persons and builds an aggregated interest profile of the individual persons; and an interest profile database configured to store the aggregated interest profile of the individual persons, wherein the aggregated interest profile of the individual persons is based on information transmitted from the controller which receives image signals captured by the plurality of cameras, processes the image signals, identifies that a person appears in an image represented by the image signals, analyzes person's interest, and creates interest profile of the person.

This invention makes it possible to continuously adapt the presented material on displays to the interest of the customer without explicitly requiring any interactive action. The use of statistics from mobile terminals, which are used in the vicinity of the deployment also enables further refinement of the media objects presented. This invention also contributes to higher effect of the marketing investment for the store, shopping mall or market, and hence higher sales.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention:

FIG. 1 is a schematic conceptual view of an advertisement display system of an exemplary embodiment according to the present invention;

FIG. 2 is an example of goods initially displayed on screens of the displays;

FIG. 3 is another example of goods newly displayed on screens of the displays;

FIG. 4 is a block diagram showing functions of the controller;

FIG. 5 is a block diagram showing functions of the local server;

FIG. 6 is an example of a schematic overview of the system deployment;

FIG. 7 shows an operational system flow;

FIG. 8 is a block diagram showing the relationship between the components and information flow to derive the images to be displayed and schedule; and

FIGS. 9 and 10 are flowcharts showing display control of images to be displayed in a plurality of displays in a single cluster.

### DETAILED DESCRIPTION

A preferred embodiment of the present invention will now be described in detail in accordance with the accompanying drawings.

The core features of a display system of the preferred embodiment according to the present invention are as follows.

(1) The ability to select an appropriate image based on a customer's implicit input (the duration and direction of the customer's gaze), based on the input from cameras attached to the displays.

(2) The control ability for managing the displays and cameras.

(3) The ability to dynamically select images based on input from a processing result of the pictures or video taken by the cameras attached to the displays, where a processor in a controller functions to analyze the customer's gaze, inferred objects gazed by the customer and history (during a defined period of time) of those analyses.

(4) The combination with the statistics from mobile phones located in a target area to enable further personalization.

In this specification, the content to be displayed is discussed in generic terms, as “media objects”. These can be still images, video, sound, text, or any combination of these or other types of media which are possible to present. In addition, these media objects have metadata describing their content, type, interest area, annotations by the content provider, etc. Such metadata is well known and not further discussed here.

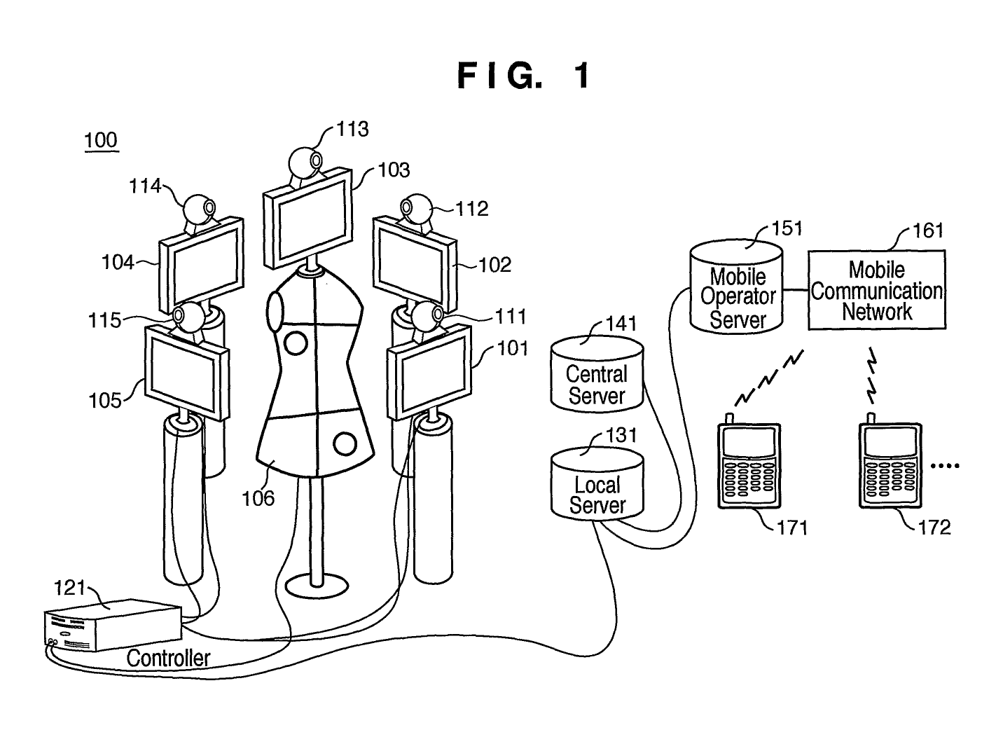

FIG. 1 is a schematic conceptual view of an advertisement display system 100 of an exemplary embodiment according to this invention. The system 100 comprises the following components: displays 101-105; digital cameras 111-115 attached to displays 101-105 respectively; a controller 121 for controlling multiple displays 101-105 and digital cameras 111-115; a local server 131, connected to the controller 121, for controlling the different inputs and outputs to/from the controller 121 and serving as a local cache for the metadata, profiles, and contents to be displayed; and a central server 141, connected to the local server 131, for controlling the data disseminated to the local servers 131, for instance the contents and metadata for the content. The central server 131 has an image database for storing various kinds of image data corresponding to various kinds of images used for advertising various products and goods. In other words, the central server 131 serves as a data center.

As shown in FIG. 1, displays 101-105 and cameras 111-115 are arranged around an exhibited product (in this case, mannequin 106). Depending the product to be exhibited, displays 101-105 and cameras 111-115 may be arranged close to the product, between the products, or on the product.

Although a single controller 121 and a single local server 131 are illustrated in FIG. 1, the system 100 may contains a plurality of local servers 131, a plurality of controllers 121 each of which controls a number of displays and digital cameras. In this case, a single controller and its associated cameras and displays, which are installed in a single site, form a cluster. And, a number of clusters, which are controlled by a single local server, may be deployed in different sites. Note that although one controller shown in FIG. 1 handles five (5) displays and five (5) digital cameras, each controller 121 can handle the limited number of displays and digital cameras according to the capability of the hardware and software.

For example, let us consider a department store of a five-storey building. In the building, a food section is in the basement, a cosmetic and jewelry section is in the ground floor, a lady's wear and goods section is in the second floor, a men's wear and goods section is in the third section, a kid's wear section is in the forth floor, and a sport goods and hobby section is in the fifth floor. Then, each one of local servers is installed in each floor, a number of clusters under the same local server are deployed in the same floor but different sites according to items exhibited, and a single central server controls all local servers. Of course, it goes without saying that the system configuration is not limited to this example. Various deployments, and system configurations are still possible.

The communication between the controller 121 and the local server 131 can be performed in different ways, for example, using a loosely coupled event communication protocol such as WARP (see https://labs.ericsson.com/apis/web-connectivity) or SIP Subscribe-Notify. In any case, a persistent relationship is assumed to be established between these two components, so that events which occur can be easily communicated. These events can for example be a user view of a particular screen of any of the displays, or a change in the content cache. The same protocol can also be used to control the update of the cache, so that it is actively pre-populated with the most current media objects (i.e. those which are most frequently watched in other locations).

Displays 101-105 have conventional passive screens, which only displays what they receive from the controller 121. The screens are addressable by the controller 121 so that each screen can be updated individually.

Digital cameras 111-115 are individually addressable so that the input from these cameras can be related to the screen. The camera angles towards each other are either known or can be analyzed by image processing software in the controller 121 so that the different angles can be used as the basis for the composition of three-dimensional images.

As shown in FIG. 1, the system may optionally connect to a mobile operator's server 151 so that the system 100 can acquire location information of a number of mobile phones 171, 172, whose users visit the system deployment site, via a mobile communication network 161.

The mobile operator server 151 serves as an interface between the mobile operator and the system 100. It is equivalent to a location application server, but provides additional data about the mobile phones and their users. The level of the information provided can be filtered according to generic settings of the operator, or based on individual settings of the user, for instance based on the GEOPRIV standard (RFC 5491). The mobile operator server 151 does not provide individualized data but aggregates statistics for the users who move around the system deployment sites. The mobile communication network 161 provides the information which is used by the mobile operator server 151.

The mobile phones 171, 172 may have a GPS function, and transmits their location information to the mobile operator server 151 via the mobile communication network 161. If a certain contract has been made between the mobile operator and the system's owner and a predetermined communication protocol has been established between the local server 131 and the mobile operator server 151, the system 100, particularly the local server 131, can communicate with the mobile operator server 151, and obtain location information of the mobile phones whose user visit the system deployment sites. In other words, the local server 131 receives the statistics from the mobile phones in the deployment area.

As indicated from FIG. 1, although the statistics can be derived from one single operator, these statistics will be more reliable if derived from more than one operator. This is particularly true in areas where the operators have customers with different interest profiles, for instance where there are MVNOs (Mobile Virtual Network Operators) directed towards young people, older people, girls, ice hockey fans, etc.

To receive statistics from more than one operator, it is necessary to have an entity which interfaces them. This can be a broker, reselling the derived statistics from the network to the owners of the digital signage. In this case, the mobile operator server 151 will interface to the broker server, using e.g. XML documents controlled by BPEL to download the data.

Although the central server and local server are illustrated separately in FIG. 1, the central server and one of the local servers may be installed in the same site, and may be integrated into a single unit. Alternatively, the central server itself may be installed, for example, in the department store's headquarters apart from all of the local servers.

The central server and each of the local servers are sometimes called nodes, respectively.

Furthermore, as indicated from the illustration of FIG. 1, the system 100, particularly each cluster employs a plurality of displays with small-sized screens (e.g. 17, 19, 21, or 23 inches). Such coordination of multiple displays with small screens co-located in the same location (e.g. in a display of clothing) contributes to providing a more attractive display to a customer. In addition, such coordination allows for the addition of special effects to these displayed images.

For example, consider that several clusters are installed in the basement of the department store as discussed above, where the grocery department is situated. Using the mechanisms discussed in this specification, many small displays are placed among the vegetables, meat or other product; and these displays occasionally show viewers attractive images mixed with advertisement and hold their attention. The proportion of the displayed images which capture and hold the interest of the viewers is determined by the previously described mechanisms. When there is a desire from the store (i.e., the store's manager (system operator)) to move people towards a different department, for instance to sell out the ready-made foods before closing time, the displays would increase the images capturing the interest of viewers (like the images of themselves), and mix these images with more advertisement for ready-made foods in the sections where there were more people. By detecting the facial direction of the customers, it would be able to enforce any movement in a desirable direction by mixing images of the desired goods with images of the customers themselves (for instance, by displaying the images of the customers far away, so that they would have to move to the image to see it), as well as other images which has been shown to capture their interest.

The same mechanism can be used to entice the customers to move from one department to another. Hence, the control of the images can be used to direct the movement of the customers throughout the store.

The images can also be displayed in sequence with the other displays so that the movement of viewers throughout the store is staggered, achieving the perception that, for example, the box-lunch department is the place to be.

The same mechanism could also be applied in an emergency situation, directing customers to the appropriate exits or gathering points by coordinating the displays.

FIG. 2 is an example of goods displayed on screens 101a, 102a, 103a and 104a of the displays 101-104. As shown in FIG. 2, the four screens initially display shoes, T-shirt, ladies' hat, and necktie, respectively.

If the customer watches the screen 102a of the display 102 for some time, and does not glance at the screen 103a of the display 103, the displayed item in the screen 103a shifts from the currently displayed image to the appropriate image. This shifts may be based on an ongoing campaign, an image analysis for determining whether or not the viewer is a woman (based on posture, body shape, etc), and/or the screen which the viewer has showed interest in for a reliable duration of time. This shift will be described in detail later.

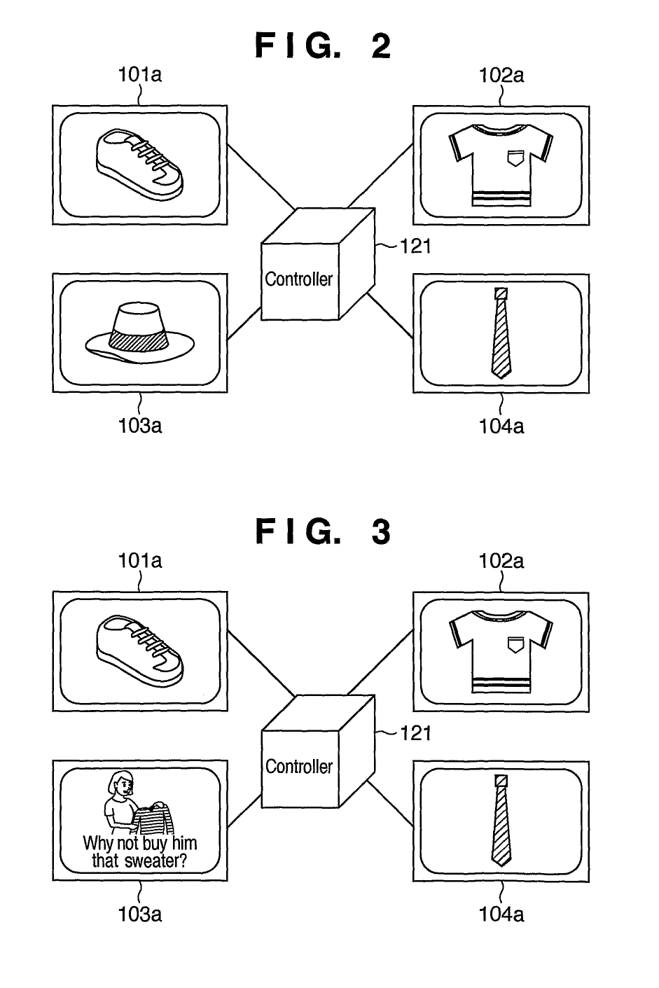

FIG. 3 is another example of goods displayed on screens 101a, 102a, 103a and 104a of the displays 101-104. As apparent from a comparison between FIG. 2 and FIG. 3, FIG. 3 shows the new display configuration. Particularly, the screen 103a displays a new image different from that in FIG. 2.

Note that although the images displayed are still images in FIGS. 2 and 3, the videos and other multimedia formats can be displayed.

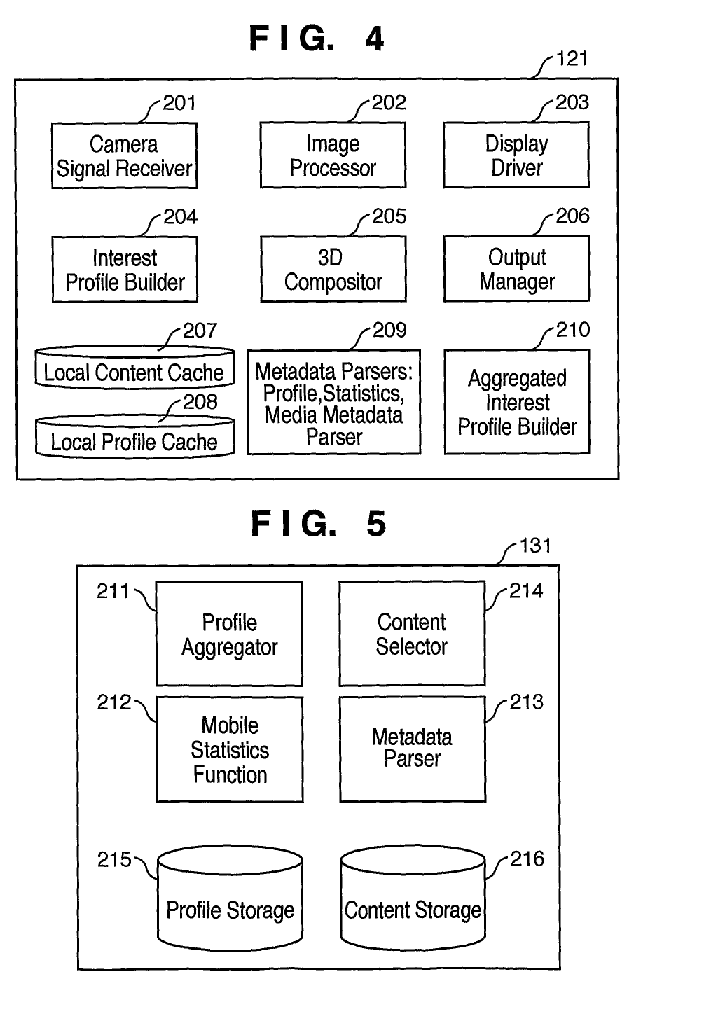

FIG. 4 is a block diagram showing functions of the controller 121. As mentioned above, the controller 121 can handle the limited number of displays and digital cameras. As capabilities of devices and processors in the controller 121 increase, the controller 121 can handle a greater number of displays and digital cameras. In addition, specialized implementations in hardware are possible. In this specification, there is no assumption about the number of displays and digital cameras which can be managed by each controller.

As outlined in FIG. 4, each controller comprises a number of logical functional components, which can be implemented in hardware or software.

The components are: camera signal receiver 201; image processor 202; display driver 203; interest profile builder 204; 3D compositor 205; output manager 206; local content cache (memory) 207; interest profile cache (memory) 208; metadata parsers 209; and aggregated interest profile builder 210. Thus, the controller comprises a CPU (not shown) and a memory. The CPU accesses to the memory, reads out targeted software stored in the memory or storage device, and executes it.

The camera signal receiver 201 receives the signal from the cameras 111-115 and transmits it to the image processor 202. The camera signal receiver 201 is typically activated once per camera. The image processor 202 receives the image data from the camera signal receiver 201 and collates them. If the camera angle (related to other cameras) is not provided from the camera signal receiver 201, these angles can be determined from the images received, using common reference objects (such as the items and the products they currently are displaying, which since they are known by the controller 121 can function as reference objects). The display driver 203 manages the output from the controller 121 into the displays 101-105. It is typically activated once per display.

The interest profile builder 204 receives the images from the 3D compositor 205, analyzes whether a face is present in the image, where it is looking, and the duration of time it is looking in that direction. This is correlated to the displayed images to determine which displayed image was the focus of interest, or else which other part of the store was being watched. This information is then fed back to the output manager 206, and also stored in the interest profile cache 208. The 3D compositor 205 takes the images received from the image processor 202 and composes them to a 3D (three-dimensional) image, using known reference points and/or camera angles. Since the cameras are observing the customer from different angles, the 3D compositor 205 can compose a 3D image of the customer's face, and potentially body.

The 3D image of the customer can also be used to determine the physiological conditions of the customer (whether it is a man or woman watching, whether the person is overweight or slim, etc). Basic color recognition can also be applied to determine suitable colors for the particular customer, based on heuristics (e.g. a user with brown hair would not look good in a beige sweater). Color recognition can also be applied to clothing held up or tried on by the customer.

The output manager 206 determines which media object from the local content cache 207 should be displayed on which screen, and also schedule of displaying the selected images on the selected displays and the relative positions on the screens, talking into consideration the interest of the user and the generic interest profile of users in the local area received from the mobile operator (as statistics). It uses the input from the metadata parsers 209.

The local content cache 207 is synchronized with the content storage in the local server 131, and contains the media objects to be displayed on the screens, and their metadata. The interest profile cache 208 contains the interest profiles derived from the interest profile builder 204. The interest profiles are continuously updated. The interest profile cache 208 keeps interest profile of the user during a defined period of time (e.g., the time since the user enters the store) so that it can provide a collection of interest profiles (history) in the past during the period.

The metadata parsers 209 contain a profile parser, a statistics parser, a media metadata parser. The media objects, as was mentioned initially, are associated with metadata. In addition, the interest profiles can be seen as metadata for the users, as well as the statistics received from the mobile operator relevant to the area where the system 100 is deployed. These metadata, some of which will be in standardized formats, will be parsed by the relevant parser and the parsed result input to the output manager 206.

The aggregated interest profile builder 210 receives interest profile of individual customers created by the interest profile builder 204 and builds an aggregated interest profile of the customers. The build aggregated interest profile of the customers is sent to the local server 131. One of the simplest examples of aggregated profile is a common interest set or a set of interests which are closer in terms of certain criteria.

FIG. 5 is a block diagram showing functions of the local server 131. As shown in FIG. 5, the local server 131 contains the following components: profile aggregator 211; mobile statistics function 212; metadata parser 213; content selector 214; profile storage 215; and content storage 216.

The profile aggregator 211 receives the interest profiles from the controller 121, and aggregates them so that each deployment site has an updated profile regarding which media objects and/or other objects in the store was the most attractive interest. The mobile statistics function 212 receives the statistics for the position where the local server 131 is deployed. These statistics are assumed to either be received in a format which is possible to compare to the content metadata; or be transformed into such a format by this function. This function also manages the communications with the mobile operator server 151, using relevant protocols such as WARP or SIP. In other words, the mobile statistics function 212 plays a role in interfacing with the mobile operator server 151.

The metadata parser 213 parses the content metadata, the statistics, and the profile, and directs the result to the content selector 214. The content selector 214 selects the content (from the content storage 216) that is to be populated into the local content cache 207 in the controller 121, based on the input from the metadata parser 213. This implies that the selected content represents a generic profile of the visitors to the store, and that it will be continuously refined as the users express interest implicitly. The content can also be predicated on campaigns etc. by the metadata when this is set by the central server 141.

The profile storage 215 stores the aggregated profiles from the controller 121, i.e. the aggregated interest by the customers of the store. It also stores the received statistics from the mobile communication network 161, which implies that it will continuously build a refined profile of each store. The content storage 216 handles the storage of media objects as received from the central server 141, enabling the content selector 214 to select which objects should be distributed to the local content cache 207 in the controller 121.

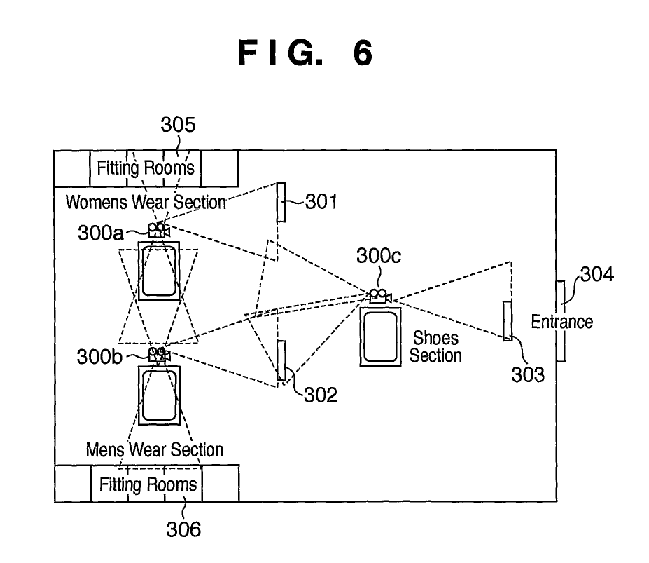

As mentioned before, the system is deployed in a store, shopping mall or market. FIG. 6 is an example of a schematic overview of the system deployment. As outlined in FIG. 6, the view angles of the cameras 300a-300c are planned so that they both cover the displays and area in front of the cameras in the cluster managed by the controller (not shown in FIG. 6). A typical deployment would also cover other points of interest within the store, such as the other displays 301-303, the door (entrance) 304, and the fitting rooms 305-306.

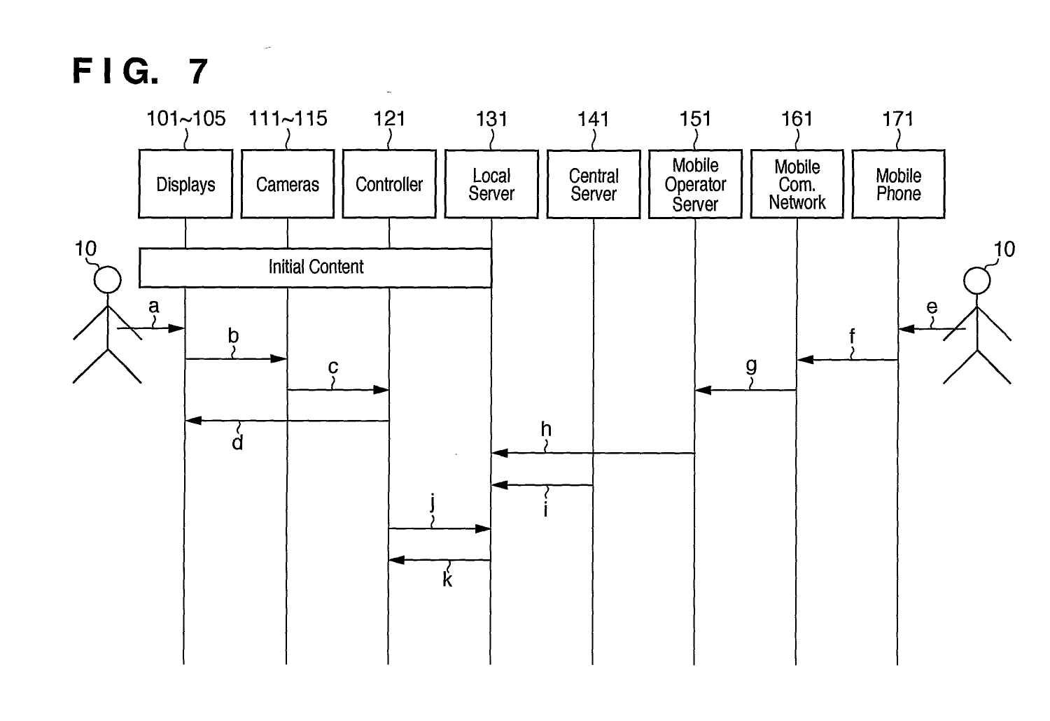

Next, a general operation of the above-mentioned system will be described with reference to FIGS. 1, 2, 3 and 7. FIG. 7 shows an operational system flow.

An assumption is that the contents have been provided to the displays before a customer enters the store. The use of the system 100 is then as follows:

a. a customer 10 views the advisement on the screen of any of the displays 101-105;

b. the cameras 111-115, respectively, captures the customer viewing the advisement from different angles;

c. the customer's views from different angles are delivered to the controller 121 via the cameras 111-115;

d. the controller 121 updates the contents displayed on the screen based on the customers view (time, screen);

[In a case where the customer holds a mobile phone, and the mobile phone is turned on,]

e. the customer 10 at the same time as “a” enters the communicable location of her/his mobile phone 171;

f. the location data of the mobile phone is automatically transmitted to the mobile communication network 161;

g. the location data and its associated mobile phone data such as the subscriber's number and ID are transmitted to the mobile operator server 151 from the mobile communication network 161. The mobile operation server 151 may filter the customer's information so that only necessary information for the system can be transmitter to the system 100.

h. the mobile operator server 151 reports the statistics about mobile phone usage in the communicable area to the local server 131;

i. the local server 131 receives the contents from the central server 141 (Note that this event can be independently initiated);

j. the controller 121 updates the customer's profile on the local server 131; and

k. the local server 131 updates the contents on the controller 121 so that the controller 121 can determine the images to be displayed and schedule them.

The above process is then repeated, and the profile continuously refined.

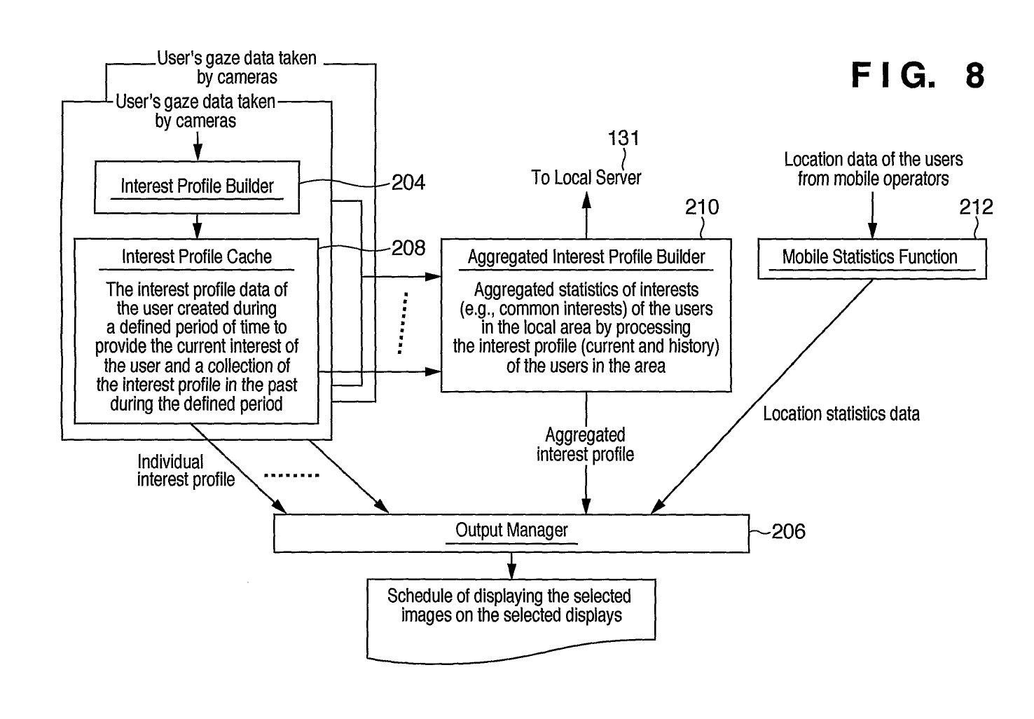

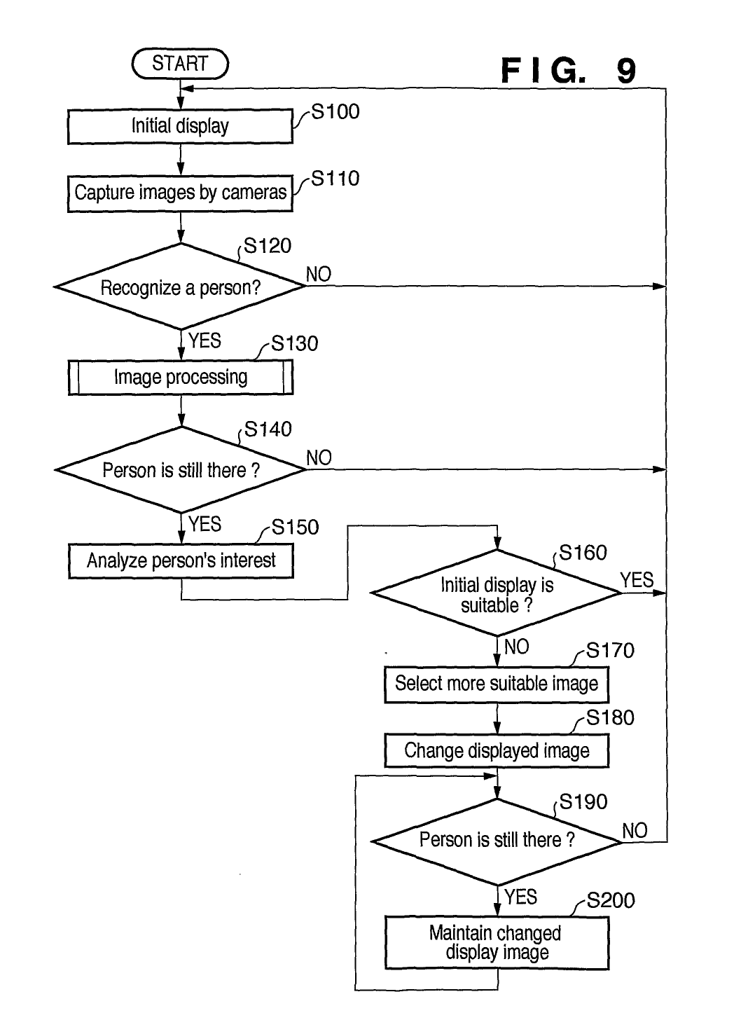

FIG. 8 is a block diagram showing the relationship between the components and information flow to derive the images to be displayed and schedule. Note that use of input from the aggregated interest profile builder 210 may be optional, i.e., such input may be used only if it is required. Also, individual customers whose interest profiles are input at the same time are adaptively determined.

The simplest case is that only one customer is selected as a target user to whom a set of the screens of the displays in one installation site is allocated to display the selected images on those screens. In this case, the cameras 101-115 in the installation site capture the customer's action, particularly face direction (i.e. where and how long the customer is looking at). This information which shows the current interest of the customer is sent to the controller 121 from each camera as the user' gaze data. Then, the interest profile builder 204 in the controller 121 edits the information and creates/updates the user's profile, and stores/maintains the user's profile into the interest profile cache 208 during a predetermined period of time. In the same time, the user's profile is sent to the output manager 206 so that it can run a program for determining and scheduling images to be displayed in the displays 101-105.

Upon determining and scheduling images to be displayed in the displays 101-105, the output manager 206 may optionally receive aggregated interest profile from the aggregated interest profile builder 210 and/or location statistics data from the mobile statistics function 212, and consider them.

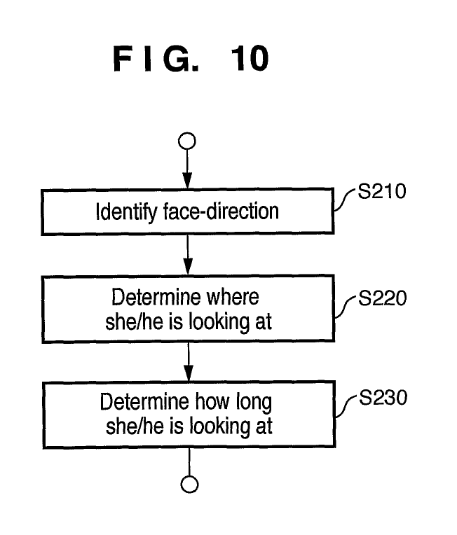

FIGS. 9 and 10 are flowcharts showing display control of images to be displayed in a plurality of displays in a single cluster. Note that for the sake of simplicity of explanation, the following description and the flowcharts assume that only one person is standing in front of the displays 101-105. However, this invention is also applicable to a case where more than one person are standing in front of these displays and they are looking at different displays.

At step S100, initial images are displayed in the displays 101-105, as shown in FIG. 2. At step S110, the controller 121 intermittently or continually receives image data from the cameras 111-115, and at step S120 examines from the received image data whether or not a person is standing in front of any one of displays 101-105 or the mannequin 106. If it is recognized at step S120 that a person is standing there, the process proceeds to step S130. On the other hand, if it is recognized at step S120 that nobody is there, the process returns to step S100. Note that since such recognition algorithm is well known, the detailed description is omitted here.

At step S130, the image processing in connection with the recognized person is performed based on the received image data. Note that since such image processing is also well known, the detailed description is not explained here. As shown in FIG. 10, through the image processing, the person's face direction is identified at step S210. And, it is determined at step S220 where she/he is looking at. This determination is based on each camera's relative angle and relative position in respect with the recognized person. When the cluster has been deployed, the system has obtained information about each camera's position and angle, and each display's position and angle. Thus, the image processor 202 can calculate based on these data where she/he is looking at. Also, it is determined at step S230 how long she/he is looking at. The determination is based on analysis of a plurality of consecutive images over times from the displays from different angles. The image processor 202, the interest profile builder 204, and the 3D compositor 205 contribute to the above image processing.

Returning to FIG. 9, at step S140, it is determined from the image processing whether or not the recognized person is still there. If it is determined that the recognized person is still there, the process proceeds to step S150. On the other hand, it is determined that the recognized person is not already there, the process returns to step S100 to maintain the initial display. From the image processing, the system gets to know what the person is looking at.

At step S150, the interest profile builder 204 analyzes what the person is interested in, and creates the person's individual interest profile. For example, if the recognized person is looking at the lady's hat displayed on the screen 103a as shown in FIG. 2, the interest profile builder 204 infers based on the above image processing that the person is most likely to be a lady. On the other hand, the other three images advertise the men's goods as shown in FIG. 2, and this indicates that the cluster is deployed in the men's wear section. As explained in connection with FIG. 8, the created individual profile is sent to the output manager 206.

At step S160, it is determined at the output manager 206 from a comparison of initially displayed images to the created individual profile whether the initially/currently displayed image is suitable to a viewer (recognized person). Since the recognized person is in the men's wear section, it seems that the advertised image which she is looking at is not suitable to the place where she is. If it is suitable, the process simply returns to step S100. However, if it not suitable, the process proceeds to step S170 to select a more suitable image from the local content cache 207. If there is no suitable image content in the local content cache 207, the controller 121 communicates with the local server 131 so that the controller 121 can download the suitable image contents from the content storage 216 of the local server 131.

Upon selecting a more suitable image, the output manager 206 may optionally consider: i) the generic interest profile downloaded from the profile storage 215 of the local server 131; ii) a common interest from the aggregated interest profile builder 210; and iii) location statistics data from the mobile statistics function 212 of the local server 131.

At step S180, the output manager 206 and the screen driver cooperate with each other, and transmit the image data corresponding to selected image content so that the display can change the displayed image as shown in FIG. 3. In FIG. 3, a new advertisement image is displayed at the screen 103a, attracting the person (most likely a lady) to buy a product.

At step S190, it is determined from the image processing whether or not the recognized person is still there. If it is determined that the recognized person is still there, the process proceeds to step S200 to maintain the displayed image. On the other hand, it is determined that the recognized person is not already there, the process returns to step S100 to display the initial image.

According to the embodiment as described above, more attractive advertising images are presented before the customer by coordinating the control of the displayed image at the displays located throughout the store with the location and direction of visitors through the store, and by applying special effects to these images and re-displaying them to the viewers. The selection of advertising image is further predicated on information known about the store visitors from their interactions with the store systems (e.g. cash register), and their mobile phones. From the mobile phones, statistics about the customers in the general area can be determined, for example their age, which can be further input to the section of the advertising image.

As many apparently widely different embodiments of the present invention can be made without departing from the spirit and scope thereof, it is to be understood that the invention is not limited to the specific embodiments thereof except as defined in the appended claims.

1. An advertisement system including:
a local server,
a controller connected to the local server; and
a plurality of displays and cameras connected to and controlled by the controller, wherein the plurality of displays and cameras are arranged near an exhibited product for advertisement, wherein
the local server comprises a main content storage configured to store image data representing a plurality of images corresponding to advertisement contents, wherein the local server connects a plurality of clusters, each including a plurality of displays and cameras, deployed in different sites such that view angles of the plurality of cameras included in each cluster cover the displays and areas in front of the cameras in each cluster and particular points of interest in the deployed site, and
the controller comprises:
a receiver unit configured to receive image signals captured by the plurality of cameras in the cluster;
a processing unit configured to process the image signals received by the receiver unit to determine whether or not a person is in an image represented by the image signals, identify where the person is looking at based on information about each camera's position and angle and each display's position in the cluster if the person is in the image and how long the person is looking at based on analysis of a plurality of consecutive images over times from the displays from different angles in the cluster, and analyze the person's interest based on the identified information;
a local content storage configured to store image data which is part of the image data stored in the main content storage of the local server and is delivered from the main content storage of the local server;
a display output manager unit configured to select image data suitable for display from the local content storage or the main content storage, based on a result of analysis obtained from the processing unit; and
a display driver unit configured to transmit the image data selected by the display output manager unit to any of the plurality of displays where the person is nearby so as to dynamically change any of displayed images according to the person's interest.

2. The system according to claim 1, wherein the local server further comprises an interface unit configured to communicate with an external mobile network server connected to a mobile communication network which communicates with a plurality of mobile phones.

3. The system according to claim 2, wherein each of the plurality of mobile phones includes a GPS function, and transmits its own location information to the mobile communication network.

4. The system according to claim 3, wherein the interface unit receives statistics of location information on each of the plurality of mobile phones from the external mobile network server.

5. The system according to claim 4, wherein the display output manager unit considers the statistics upon selecting image data suitable for display.

6. The system according to claim 1, further comprising a central server, serving as a data center, which disseminates image data to the local server.

7. The system according to any claim 1, wherein a number of the local servers are connected to the central server.

8. The system according to claim 1, wherein the display output manager controls selections of images to be displayed in each of the clusters such that viewers of the images are motivated to move to an intended place by the system operator.

9. The system according to claim 8, wherein the selection of the images is based on at least one of: a time when the images are displayed; the exhibited products for advertisement; and the intended place.

10. The system according to claim 1, wherein the plurality of displays initially display the respective images related to the exhibited product,
the plurality of cameras are arranged in different positions such that the plurality of cameras capture a person near the exhibited product from different angles as a plurality of images, and
the processing unit comprises:
an image processor unit configured to input the image signals received by the receiver unit and collate the image signals taken from the different angles by the plurality of cameras;
a 3D composing unit configured to compose the collated image signals and create a three-dimensional (3D) image;
a local interest profile builder unit configured to, based on the 3D image, determine the person's face direction and infer the person's interest; and
an interest profile memory configured to store the inferred person's interest as an interest profile of an individual person.

11. The system according to claim 10, wherein the local interest profile builder further determines the person's physiological conditions, based on the 3D image, and if the 3D image is a color image, further determines the person's physical nature based on color recognition.

12. The system according to claim 11, wherein the local interest profile builder infers the person's interest, based on the person's physiological conditions and the color recognition result.

13. The system according to claim 10, wherein the display output manager unit compares the initially displayed images with the inferred person's interest, and determines whether or not the initially displayed images are suitable to the person.

14. The system according to claim 10, wherein the local server further comprises:
a profile aggregation unit configured to aggregate interest profile of individual persons and builds an aggregated interest profile of the individual persons; and
an interest profile database configured to store the aggregated interest profile of the individual persons.

15. The system according to claim 14, wherein the controller further comprises an aggregated interest profile builder unit configured to receive the inferred person's interest, aggregate interest profile of individual persons, and transmit the aggregated interest profile of the individual persons to the local server, and
the profile aggregation unit receives the aggregated interest profile of the individual persons from the controller, and updates the aggregated interest profile of the individual persons in the interest profile database.

16. A method of controlling display of image in an advertisement system including: a local server; a controller connected to the local server; and a plurality of displays and cameras connected to and controlled by the controller, wherein the plurality of displays and cameras are arranged near an exhibited product for advertisement, and the local server connects a plurality of clusters, each including a plurality of displays and cameras, deployed in different sites such that view angles of the plurality of cameras included in each cluster cover the displays and areas in front of the cameras in each cluster and particular points of interest in the deployed site, comprising the steps of:
storing, in a main content image database provided in the local server, image data representing a plurality of images corresponding to advertisement contents;
storing, in a local content storage provided in the controller image data which is part of the image data stored in the main content storage and is delivered from the main content storage;
receiving, at a receiver unit provided in the controller, image signals captured by the plurality of cameras in the cluster;
processing, at a processing unit provided in the controller, the received image signals to determine whether or not a person is in an image represented by the image signals, identify where the person is looking at based on information about each camera's position and angle and each display's position in the cluster if the person is in the image and how long the person is looking at based on analysis of a plurality of consecutive images over times from the displays from different angles in the cluster, and analyze the person's interest based on the identified information;
selecting, at a display output manager unit provided in the controller, image data suitable for display from the local content storage or the main content storage, based on a result of analysis obtained from the processing unit; and
transmitting, by a display driver unit provided in the controller, the selected image data to any of the plurality of displays where the person is nearby so as to dynamically change any of displayed images according to the person's interest.

17. A controller for controlling display of an image to be displayed in a display in an advertisement system including: a server connected to the controller for storing image data representing a plurality of images corresponding to advertisement contents; and a plurality of displays and cameras connected to and controlled by the controller, wherein the plurality of displays and cameras are arranged near an exhibited product for advertisement, and the server connects a plurality of clusters, each including a plurality of displays and cameras, deployed in different sites such that view angles of the plurality of cameras included in each cluster cover the displays and areas in front of the cameras in each cluster and particular points of interest in the deployed site, comprising:
a receiver configured to receive image signals captured by the plurality of cameras in the cluster;
a processing unit configured to process the image signals received by the receiver unit to determine whether or not a person is in an image represented by the image signals, identify where the person is looking at based on information about each camera's position and angle and each display's position in the cluster if the person is in the image and how long the person is looking at based on analysis of a plurality of consecutive images over times from the displays from different angles in the cluster, and analyze the person's interest based on the identified information;
a content storage configured to store image data which is part of the image data stored in the server and is delivered from the server;
a display output manager unit configured to select image data suitable for display from the content storage or the server, based on a result of analysis obtained from the processing unit; and
a display driver unit configured to transmit the image data selected by the display output manager unit to any of the plurality of displays where the person is nearby so as to dynamically change any of displayed images according to the person's interest.

18. A server in an advertisement system including: a controller connected to the server; and a plurality of displays and cameras connected to and controlled by the controller, wherein the plurality of displays and cameras are arranged near an exhibited product for advertisement, and the server is operable to connect a plurality of clusters, each including a plurality of displays and cameras, deployed in different sites such that view angles of the plurality of cameras included in each cluster cover the displays and areas in front of the cameras in each cluster and particular points of interest in the deployed site, the server comprising:
a content storage configured to store image data representing a plurality of images corresponding to advertisement contents, wherein the image data is delivered to the controller;
a profile aggregation unit configured to aggregate interest profile of individual persons and builds an aggregated interest profile of the individual persons; and
an interest profile database configured to store the aggregated interest profile of the individual persons,
wherein the aggregated interest profile of the individual persons is based on information transmitted from the controller which receives image signals captured by the plurality of cameras in the cluster, processes the image signals, identifies where a person appeared in an image represented by the image signals is looking at based on information about each camera's position and angle and each display's position in the cluster and how long the person is looking at based on analysis of a plurality of consecutive images over times from the displays from different angles in the cluster, analyzes person's interest, and creates interest profile of the person.

19. (canceled)
